(19) United States
(12) Patent Application Publication
(10) Pub. No.: US 2007/0279310 A1
(43) Pub. Date: Dec. 6, 2007

(54) Wireless communication device

(75) Inventors: Feng-Chi Eddie Tsai, Taipei Hsien (TW); Chih-Ming Wang, Taipei Hsien (TW)

Correspondence Address: BACON & THOMAS, PLLC, 625 SLATERS LANE, FOURTH FLOOR, ALEXANDRIA, VA, 22314, US

(73) Assignee: WISTRON NEWEB CORP., Taipei Hsien (TW)

(21) Appl. No.: 11/652,636

(22) Filed: Jan. 12, 2007

(30) Foreign Application Priority Data
Jun. 1, 2006 (TW) 095209478

(51) Int. Cl. H01Q 9/28

(52) U.S. Cl. 343/795; 343/700 MS

(57) ABSTRACT

A wireless communication device comprises a host, a first antenna, a second antenna and a third antenna. The host is capable of being disposed on a ceiling or a wall; and the first antenna, the second antenna and the third antenna are rotatably coupled to the host in a predetermined arrangement. When the first antenna, the second antenna and the third antenna are rotated to a predetermined angle, a radiation field formed by the first antenna, the second antenna and the third antenna is an omni-directional field shape on a horizontal cross-sectional direction, and is a downward field shape on a vertical cross-sectional direction.

### BACKGROUND OF THE INVENTION

1. Field of the Invention

The present invention relates to a wireless communication device, and, more particularly, to a wireless communication device having a radiation field as an omni-directional field shape on a horizontal cross-sectional direction, and is a downward field shape on a vertical cross-sectional direction.

2. Description of the Related Art

Since wireless communication devices is more and more popular and the improvement of wireless communication information transmission speed, how to chose correct antenna and its arrangement to achieve high speed transmission is very important.

Especially with the multiple-input multiple-output (MIMO) technology in IEEE 802.11n standard, the wireless transmission speed can increase from the highest transmission speed 54 Mbps of 802.11g standard to 100 Mbps.

It is therefore desirable to provide a wireless communication device having a radiation field as an omni-directional field shape on a horizontal cross-sectional direction, and is a downward field shape on a vertical cross-sectional direction to mitigate and/or obviate the aforementioned problems and match the requirement for MIMO wireless communication system.

### SUMMARY OF THE INVENTION

The present invention provides a wireless communication device having a radiation field as an omni-directional field shape on a horizontal cross-sectional direction, and is a downward field shape on a vertical cross-sectional direction to match the requirement for MIMO wireless communication system.

In one embodiment of the present invention, a wireless communication device comprises a host, a first antenna, a second antenna and a third antenna. The host is capable of being disposed on a ceiling or a wall; and the first antenna, the second antenna and the third antenna are rotatably coupled to the host in a predetermined arrangement. When the first antenna, the second antenna and the third antenna are rotated to a predetermined angle, a radiation field formed by the first antenna, the second antenna and the third antenna is an omni-directional field shape on a horizontal cross-sectional direction, and is a downward field shape on a vertical cross-sectional direction.

In one embodiment of the present invention, a distance between the first antenna and the second antenna is substantially bigger or equal to half wave length of the lowest frequency, and a distance between the second antenna and the third antenna is substantially bigger or equal to half wave length of the lowest frequency.

In one embodiment of the present invention, the first antenna, the second antenna and the third antenna are disposed on a flap; or the first antenna is disposed in a first casing, the second antenna is disposed in a second casing and the third antenna is disposed in a third casing. The first casing, the second casing and the third casing are rotatably coupled to the host, so the first antenna, the second antenna and the third antenna can be rotated to the predetermined angle by rotating the first casing, the second casing and the third casing.

In one embodiment of the present invention, the host is disposed on the ceiling; the predetermined angle is an angle substantially perpendicular to a horizontal face; and when the host is disposed on the wall, the predetermined angle is an angle substantially perpendicular to a horizontal face.

In one embodiment of the present invention, another wireless communication device comprises a metal reflection plate, a first antenna, a second antenna and a third antenna. The first antenna, the second antenna and the third antenna are disposed in a predetermined arrangement on the metal reflection plate, so a radiation field formed by the first antenna, the second antenna and the third antenna is an omni-directional field shape on a horizontal cross-sectional direction, and is a downward field shape on a vertical cross-sectional direction.

In one embodiment of the present invention, the predetermined arrangement comprises: the first antenna and the second antenna are substantially parallel with each other; a distance between the first antenna and the second antenna is substantially between about a quarter of a low frequency wave length to about one low frequency wave length; and the first antenna, the second antenna and the third antenna are substantially arranged in a U shape, a H shape or a N shape.

In one embodiment of the present invention, the predetermined arrangement comprises: a distance between each center point of the first antenna, the second antenna and the third antenna is substantially between about a quarter of a low frequency wave length to about one low frequency wave length; and each angle of a triangle formed by each center point of the first antenna, the second antenna and the third antenna is between about 15° to about 150°.

In one embodiment of the present invention, the wireless communication device further comprises a three claws oblique reflection plate disposed on the metal reflection plate; and the first antenna, the second antenna and the third antenna are disposed on the three claws oblique reflection plate. An angle between the three claws oblique reflection plate and the metal reflection is substantially between about 20° to about 80°; and a width of the three claws oblique reflection plate is substantially between about one sixth to about one third of a low frequency wave length.

In one embodiment of the present invention, the wireless communication device further comprises a first supporting frame, a second supporting frame and a third supporting frame disposed on the three claws oblique reflection plate. The first antenna is disposed on the first supporting frame, the second antenna is disposed on the second supporting frame and the third antenna is disposed on the third supporting frame. A distance between each of the first antenna, the second antenna and the third antenna and the three claws oblique reflection plate is substantially between about one sixteenth of a low frequency wave length to about one quarter of a low frequency wave length.

In one embodiment of the present invention, each antenna is a dual-band dipole antenna, a recumbent dual-band dipole antenna or a thin wide band antenna.

Other objects, advantages, and novel features of the invention will become more apparent from the following detailed description when taken in conjunction with the accompanying drawings.

### BRIEF DESCRIPTION OF THE DRAWINGS

FIG. 1A is a side view drawing of a wireless communication device disposed on a ceiling according to a first embodiment of the present invention.

FIG. 1B is a front view of the wireless communication device disposed on a ceiling according to the first embodiment of the present invention.

FIG. 2A is a side view drawing of a wireless communication device disposed on a wall according to the first embodiment of the present invention.

FIG. 2B is a front view of the wireless communication device disposed on a wall according to the first embodiment of the present invention.

FIG. 3A is a front view of the wireless communication device disposed on a ceiling according to a second embodiment of the present invention.

FIG. 3B is another front view of the wireless communication device disposed on a ceiling according to the second embodiment of the present invention.

FIG. 4 is a schematic drawing of the wireless communication device disposed on a ceiling according to a third embodiment of the present invention.

FIG. 5 is a schematic drawing of an antenna arrangement of the wireless communication device according to the third embodiment of the present invention.

FIG. 6 is a schematic drawing of another antenna arrangement of the wireless communication device according to the third embodiment of the present invention.

FIG. 7 is a schematic drawing of another antenna arrangement of the wireless communication device according to the third embodiment of the present invention.

FIG. 8 is a side view of the wireless communication device disposed on a ceiling according to a fourth embodiment of the present invention.

FIG. 9 is a schematic drawing of an antenna arrangement of the wireless communication device according to the fourth embodiment of the present invention.

FIG. 10 is a local schematic drawing of the wireless communication device embodiment according to the fourth embodiment of the present invention.

FIG. 11 is another local schematic drawing of the wireless communication device embodiment according to the fourth embodiment of the present invention.

### DETAILED DESCRIPTION OF THE PREFERRED EMBODIMENT

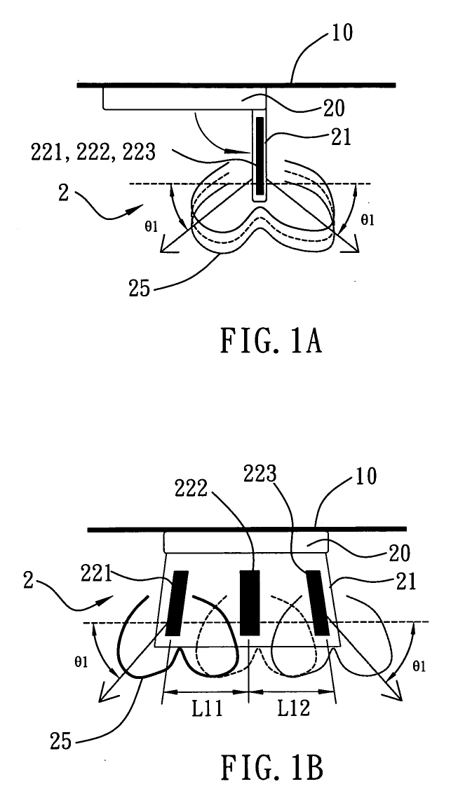

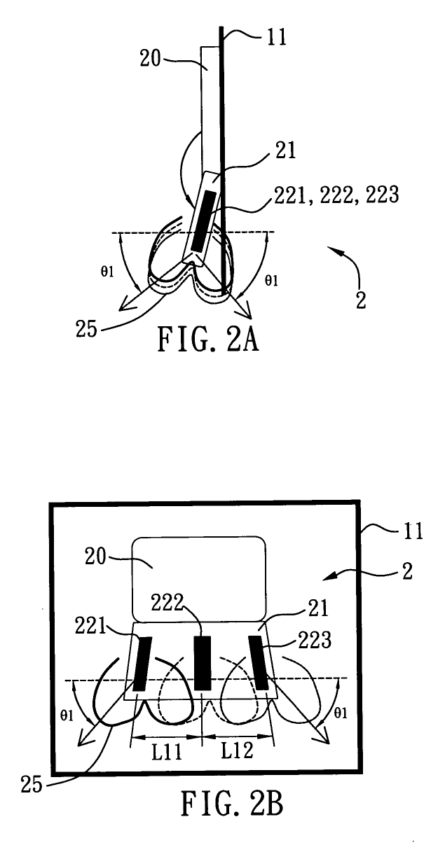

Please refer to FIG. 1A, FIG. 1B, FIG. 2A and FIG. 2B. FIG. 1A is a side view drawing of a wireless communication device disposed on a ceiling according to a first embodiment of the present invention. FIG. 1B is a front view of the wireless communication device disposed on a ceiling according to the first embodiment of the present invention. FIG. 2A is a side view drawing of a wireless communication device disposed on a wall according to the first embodiment of the present invention. FIG. 2B is a front view of the wireless communication device disposed on a wall according to the first embodiment of the present invention.

As shown in FIG. FIG. 1A, FIG. 1B, FIG. 2A and FIG. 2B, in a first embodiment of the present invention, a wireless communication device 2 comprises a host 20, a flap 21, a first antenna 221, a second antenna 222 and a third antenna 223. The host 20 can be disposed on a ceiling 10 or a wall 11; the flap 21 is rotatably coupled to the host 20, and the first antenna 221, the second antenna 222 and the third antenna 223 are disposed on the flap 21.

As shown in FIG. 1A, when the host 20 is disposed on the ceiling 10, the first antenna 221, the second antenna 222 and the third antenna 223 can be rotated to a predetermined angle by rotating the flap 21. The predetermined angle preferably is an angle substantially perpendicular to a horizontal face, but this should not be the limitation of the present invention. Similarly, as shown in FIG. 2A, when the host 20 is disposed on the wall 11, the first antenna 221, the second antenna 222 and the third antenna 223 can be rotated to the predetermined angle by rotating the flap 21. The predetermined angle preferably is close to an angle substantially perpendicular to a horizontal face, but this should not be the limitation of the present invention.

As shown in FIG. 1B and FIG. 2B, a distance L11 between the first antenna 221 and the second antenna 222 is substantially bigger or equal to half wave length of the lowest frequency; and a distance L12 between the second antenna 222 and the third antenna 223 is substantially bigger or equal to half wave length of the lowest frequency. Therefore, the first antenna 221, the second antenna 222 and the third antenna 223 are rotated to the predetermined angle as shown in FIG. 1A or FIG. 2A by rotating the flap 21, a radiation field 25 of the wireless communication device 2 is an omni-directional field shape on the horizontal cross-sectional direction and is a downward field shape on a cross-sectional direction. In addition, an angle θ1 formed by the direction of the radiation field 25 and the horizontal face is between about 30° to about 45°, which satisfies MIMO wireless communication requirement.

Furthermore, in the first embodiment of the present invention, the first antenna 221, the second antenna 222 and the third antenna 223 can all be thin wide band antennas so the flap 21 can have a thinner thickness, but this should not be the limitation of the present invention. Similarly, the first antenna 221, the second antenna 222 and the third antenna 223 can all be dual band dipole antennas, but this should not be the limitation of the present invention.

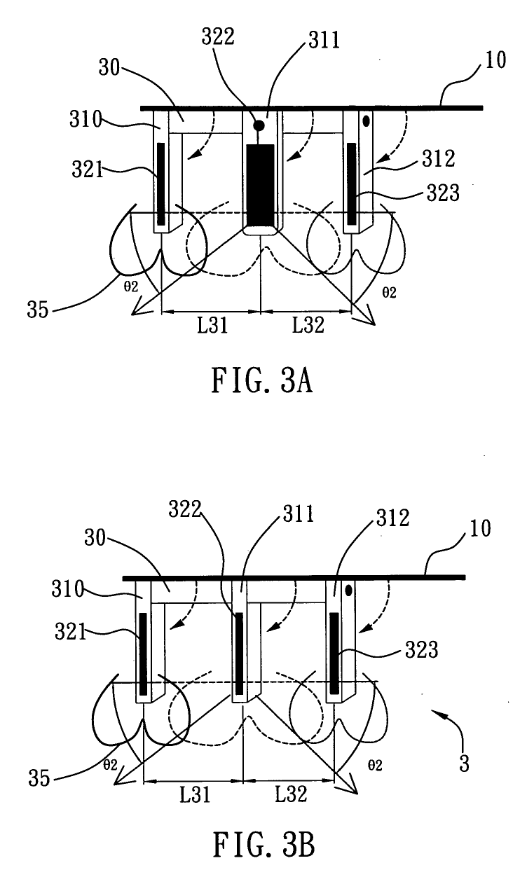

Next, please refer to FIG. 3A and FIG. 3B. FIGS. 3A and 3B are side views of the wireless communication device disposed on a ceiling according to a second embodiment of the present invention. As shown in FIG. 3A and FIG. 3B, in the second embodiment of the present invention, a wireless communication device 3 comprises a host 30, a first casing 310, a second casing 311, a third casing 312, a first antenna 321, a second antenna 322 and a third antenna 323. The host 30 is disposed on the ceiling 10, but this should not be the limitation of the present invention. The host 30 can also be disposed on the wall 11 as shown in FIG. 1B or FIG. 2B. The first casing 310, the second casing 311 and the third casing 312 are rotatably coupled to the host 30. The first antenna 321 is disposed in the first casing 310, the second antenna 322 is disposed in the second casing 311 and the third antenna 323 is disposed in the third casing 312. Similarly, a distance L31 between the first antenna 321 and the second antenna 322 is substantially bigger or equal to half wave length of the lowest frequency; and a distance L32 between the second antenna 322 and the third antenna 323 is substantially bigger or equal to half wave length of the lowest frequency.

A main difference between the second embodiment and the first embodiment of the present invention is that, in the second embodiment, the first casing 310, the second antenna 322 and the third casing 312 replace the flap 21 in the first embodiment. Therefore, by rotating the first casing 310, the second casing 311 and the third casing 312 to a predetermined angle, a radiation field 35 of the wireless communication device 2 becomes to an omni-directional field shape on the horizontal cross-sectional direction and becomes to an downward field shape on a vertical cross-sectional direction. In addition, an angle θ2 formed by the direction of the radiation field 35 and the horizontal face is between about 30° to about 45°, which satisfies MIMO wireless communication requirement. Furthermore, by rotating each casing to different angles can achieve various antenna polarizations.

In the second embodiment, as long as the radiation field 35 is an omni-directional field shape on the horizontal cross-sectional direction and is a downward field shape on the vertical cross-sectional direction, the first antenna 321, the second antenna 322 and the third antenna 323 can be disposed in different arrangements. For example, in FIG. 3A, the second antenna 322 is perpendicular to the first antenna 321 and the third antenna 323; and in FIG. 3B, the second antenna 322 is parallel with the first antenna 321 and the third antenna 323.

Furthermore, in the second embodiment of the present invention, the first antenna 321, the second antenna 322 and the third antenna 323 may all be thin wide band antennas so the first casing 310, the second casing 311 and the third casing 312 can have thinner thicknesses, but this should not be the limitation of the present invention. Similarly, the first antenna 321, the second antenna 322 and the third antenna 323 may all be dual band dipole antennas, but this should not be the limitation of the present invention.

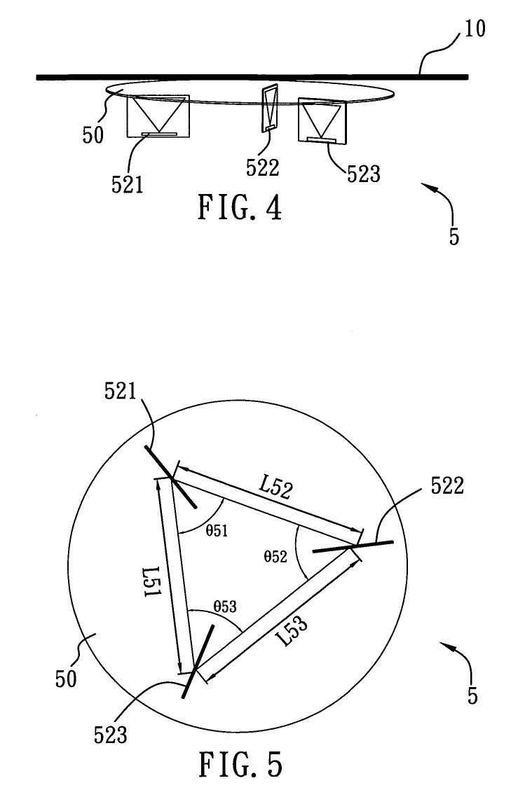

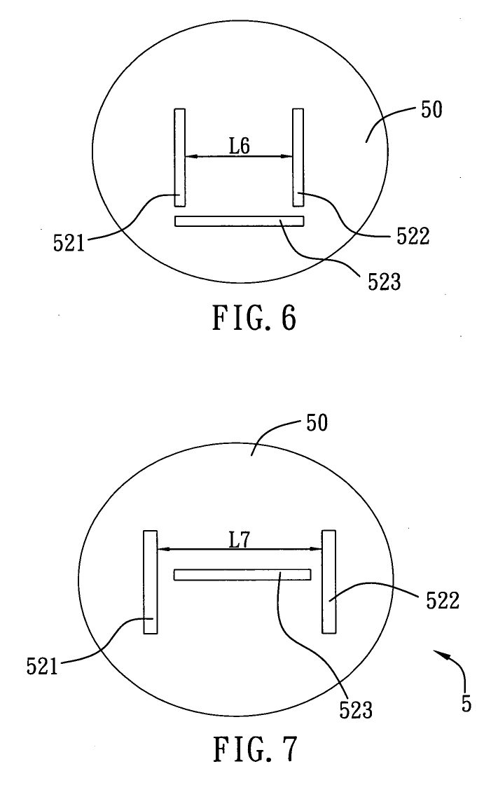

Please refer to FIG. 4, FIG. 5, FIG. 6 and FIG. 7 together. FIG. 4 is a schematic drawing of the wireless communication device disposed on a ceiling according to a third embodiment of the present invention. FIG. 5 is a schematic drawing of an antenna arrangement of the wireless communication device according to the third embodiment of the present invention. FIG. 6 is a schematic drawing of another antenna arrangement of the wireless communication device according to the third embodiment of the present invention. FIG. 7 is a schematic drawing of another antenna arrangement of the wireless communication device according to the third embodiment of the present invention.

As shown in FIG. 4, in the third embodiment of the present invention, a wireless communication device 5 comprises a metal reflection plate 50, a first antenna 521, a second antenna 522 and a third antenna 523. The first antenna 521, the second antenna 522 and the third antenna 523 are disposed on the metal reflection plate 50 in a predetermined arrangement, so when the wireless communication device 5 is disposed on the ceiling 10, a radiation field (not shown) formed by the first antenna 521, the second antenna 522 and the third antenna 523 is an omni-directional field shape on the horizontal cross-sectional direction and is a downward field shape on a vertical cross-sectional direction.

Furthermore, in the third embodiment of the present invention, the present invention can have the radiation field as the omni-directional field shape on a horizontal cross-sectional direction and as the downward field shape on a vertical cross-sectional direction by different antenna arrangements. For example, as shown in FIG. 5, the first antenna 521, the second antenna 522 and the third antenna 523 are disposed on the metal reflection plate 50 by following arrangement: a distance L51, L52 and L53 between each center point of the first antenna 521, the second antenna 522 and the third antenna 523 is substantially between about a quarter of a low frequency wave length to about one low frequency wave length; and each angle θ51, θ52 and θ53 of a triangle formed by each center point of the first antenna 521, the second antenna 522 and the third antenna 523 is between about 15° to about 150°. Alternatively, as shown in FIG. 6, the first antenna 521, the second antenna 522 and the third antenna 523 can be disposed on the metal reflection plate 50 by following arrangement: the first antenna 521 and the second antenna 522 are substantially parallel with each other; a distance L6 between the first antenna 521 and the second antenna 522 is substantially between about a quarter of a low frequency wave length to about one low frequency wave length; and the first antenna 521, the second antenna 522 and the third antenna 523 are substantially arranged in a U shape. Moreover, as shown in FIG. 7, the first antenna 521, the second antenna 522 and the third antenna 523 can be disposed on the metal reflection plate 50 as following: the first antenna 521 and the second antenna 522 are substantially parallel with each other; a distance L7 between the first antenna 521 and the second antenna 522 is substantially about a quarter of a low frequency wave length to about one low frequency wave length; and the first antenna 521, the second antenna 522 and the third antenna 523 are substantially arranged in a H shape. Furthermore, the arrangement shape of the first antenna 521, the second antenna 522 and the third antenna 523 should not be limited by the above-mentioned U shape or H shape; the antennas can be N shape or other shape.

Furthermore, in the third embodiment, the first antenna 521, the second antenna 522 and the third antenna 523 can all be dual band dipole antennas, but this should not be the limitation of the present invention. Similarly, the first antenna 521, the second antenna 522 and the third antenna 523 can all be thin wide band antennas, but this should not be the limitation of the present invention.

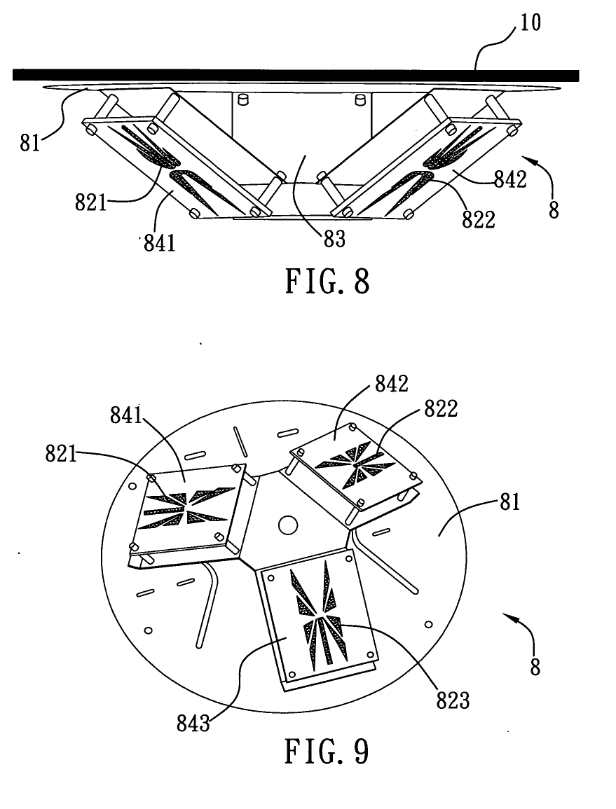

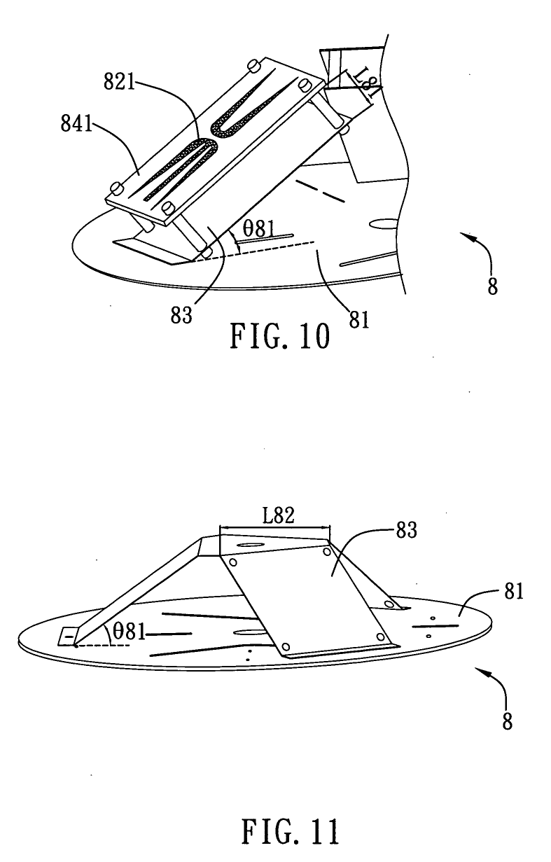

Next, please refer to FIG. 8, FIG. 9, FIG. 10 and FIG. 11. FIG. 8 is a side view of the wireless communication device disposed on a ceiling according to a fourth embodiment of the present invention. FIG. 9 is a schematic drawing of an antenna arrangement of the wireless communication device according to the fourth embodiment of the present invention. FIG. 10 is a local schematic drawing of the wireless communication device embodiment according to the fourth embodiment of the present invention. FIG. 11 is another local schematic drawing of the wireless communication device embodiment according to the fourth embodiment of the present invention.

As shown in FIG. 8 and FIG. 9, in the fourth embodiment of the present invention, a wireless communication device 8 comprises a metal reflection plate 81, a first antenna 821, a second antenna 822, a third antenna 823, a first supporting frame 841, a second supporting frame 842, a third supporting frame 843 and a three claws oblique reflection plate 83. The three claws oblique reflection plate 83 is disposed on the metal reflection plate 81; and the first antenna 821, the second antenna 822 and the third antenna 823 are separately disposed on the three claws oblique reflection plate 83 by the first supporting frame 841, the second supporting frame 842 and the third supporting frame 843.

As shown in FIG. 10, in the fourth embodiment of the present invention, the first antenna 821 is first disposed on the first supporting frame 841 and then is disposed on the three claws oblique reflection plate 83. Therefore, there is a distance L81 between the first antenna 821 and the three claws oblique reflection plate 83. The distance L81 should be substantially between about one sixteenth of a low frequency wave length to about one quarter of a low frequency wave length, but this should not be the limitation of the present invention. Similarly, the second antenna 822 and the third antenna 823 and the three claws oblique reflection plate 83 has a same distance which is about one sixteenth of a low frequency wave length to about one quarter of a low frequency wave length.

As shown in FIG. 10 and FIG. 11, there is an angle θ81 between the three claws oblique reflection plate 83 and the metal reflection plate 81, which should be substantially between about 20° to about 80°. Furthermore, as shown in FIG. 11, a width L82 of the three claws oblique reflection plate 83 is substantially about one sixth to about one third of a low frequency wave length.

With this arrangement, when the wireless communication 8 is disposed on the ceiling 10 as shown in FIG. 8, the radiation field (not shown) formed by the first antenna 821, the second antenna 822 and the third antenna 823 is an omni-directional field shape on a horizontal cross-sectional direction, and is a downward field shape on a vertical cross-sectional direction.

Furthermore, in the fourth embodiment of the present invention, the first antenna 821, the second antenna 822 and the third antenna 823 can all be dual band dipole antennas, but this should not be the limitation of the present invention. Similarly, the first antenna 821, the second antenna 822 and the third antenna 823 can all be recumbent dual band dipole antennas, but this should not be the limitation of the present invention.

Although the present invention has been explained in relation to its preferred embodiment, it is to be understood that many other possible modifications and variations can be made without departing from the spirit and scope of the invention as hereinafter claimed.

What is claimed is:

1. A wireless communication device comprising:
a host capable of being disposed on a ceiling or a wall; and
a first antenna, a second antenna and a third antenna, wherein the first antenna, the second antenna and the third antenna are rotatably coupled to the host; when the first antenna, the second antenna and the third antenna are rotated to a predetermined angle, a radiation field formed by the first antenna, the second antenna and the third antenna is an omni-directional field shape on a horizontal cross-sectional direction, and is a downward field shape on a vertical cross-sectional direction.

2. The wireless communication device as claimed in claim 1, wherein a distance between the first antenna and the second antenna is substantially bigger or equal to half wave length of the lowest frequency, and a distance between the second antenna and the third antenna is substantially bigger or equal to half wave length of the lowest frequency.

3. The wireless communication device as claimed in claim 1, wherein the first antenna, the second antenna and the third antenna are disposed on a flap, the flap is rotatably coupled to the host, so the first antenna, the second antenna and the third antenna can be rotated to the predetermined angle by rotating the flap.

4. The wireless communication device as claimed in claim 1, wherein the first antenna is disposed in a first casing, the second antenna is disposed in a second casing and the third antenna is disposed in a third casing, the first casing, the second casing and the third casing are rotatably coupled to the host, so the first antenna, the second antenna and the third antenna can be rotated to the predetermined angle by rotating the first casing, the second casing and the third casing.

5. The wireless communication device as claimed in claim 1, wherein when the host is disposed on the ceiling, the predetermined angle is an angle substantially perpendicular to a horizontal face.

6. The wireless communication device as claimed in claim 1, wherein when the host is disposed on the wall, the predetermined angle is close to an angle substantially perpendicular to a horizontal face.

7. The wireless communication device as claimed in claim 1, wherein the first antenna, the second antenna or the third antenna is a thin wide band antenna.

8. The wireless communication device as claimed in claim 1, wherein the first antenna, the second antenna or the third antenna is a dual-band dipole antenna.

9. A wireless communication device comprising:
a metal reflection plate; and
a first antenna, a second antenna and a third antenna, wherein the first antenna, the second antenna and the third antenna are disposed in a predetermined arrangement on the metal reflection plate, so a radiation field formed by the first antenna, the second antenna and the third antenna is an omni-directional field shape on a horizontal cross-sectional direction, and is a downward field shape on a vertical cross-sectional direction.

10. The wireless communication device as claimed in claim 9, wherein the predetermined arrangement comprises: the first antenna and the second antenna are substantially parallel with each other; a distance between the first antenna and the second antenna is substantially between about a quarter of a low frequency wave length to about one low frequency wave length; and the first antenna, the second antenna and the third antenna are substantially arranged in a U shape.

11. The wireless communication device as claimed in claim 9, wherein the predetermined arrangement comprises: the first antenna and the second antenna are substantially parallel with each other; a distance between the first antenna and the second antenna is substantially between about one quarter of a low frequency wave length to about one low frequency wave length; and the first antenna, the second antenna and the third antenna are substantially arranged in a H shape or a N shape.

12. The wireless communication device as claimed in claim 9, wherein the predetermined arrangement comprises: a distance between each center point of the first antenna, the second antenna and the third antenna is substantially between about a quarter of a low frequency wave length to about one low frequency wave length; and each angle of a triangle formed by each center point of the first antenna, the second antenna and the third antenna is between about 15° to about 150°.

13. The wireless communication device as claimed in claim 9, wherein the first antenna, the second antenna or the third antenna is a thin wide band antenna.

14. The wireless communication device as claimed in claim 9, wherein the first antenna, the second antenna or the third antenna is a dual-band dipole antenna.

15. A wireless communication device comprising:
a metal reflection plate; and
a three claws oblique reflection plate disposed on the metal reflection plate, an angle between the three claws oblique reflection plate and the metal reflection is substantially between about 20° to about 80°; and
a first antenna, a second antenna and a third antenna, wherein a radiation field formed by the first antenna, the second antenna and the third antenna is an omni-directional field shape on a horizontal cross-sectional direction, and is a downward field shape on a vertical cross-sectional direction.

16. The wireless communication device as claimed in claim 15, wherein a width of the three claws oblique reflection plate is substantially between about one sixth to about one third of a low frequency wave length.

17. The wireless communication device as claimed in claim 15 further comprising:
a first supporting frame disposed on the three claws oblique reflection plate, and the first antenna is disposed on the first supporting frame;
a second supporting frame disposed on the three claws oblique reflection plate, and the second antenna is disposed on the second supporting frame; and
a third supporting frame disposed on the three claws oblique reflection plate, and the third antenna is disposed on the third supporting frame;
wherein a distance between each of the first antenna, the second antenna and the third antenna and the three claws oblique reflection plate is substantially between about one sixteenth of a low frequency wave length to about one quarter of a low frequency wave length.

18. The wireless communication device as claimed in claim 15, wherein the first antenna, the second antenna or the third antenna is a dual-band dipole antenna.

19. The wireless communication device as claimed in claim 15, wherein the first antenna, the second antenna or the third antenna is a recumbent dual-band dipole antenna.

20. The wireless communication device as claimed in claim 15, wherein the first antenna, the second antenna or the third antenna is a thin wide band antenna.
